(19) United States
(12) Patent Application Publication
(10) Pub. No.: US 2010/0256814 A1
(43) Pub. Date: Oct. 7, 2010

(54) System and methods for robotic manipulation

(76) Inventor: Joshua R. Smith, Seattle, WA (US)

Correspondence Address: INTEL CORPORATION;c/o CPA Global, P.O. BOX 52050, MINNEAPOLIS, MN, 55402, US

(21) Appl. No.: 12/384,689

(22) Filed: Apr. 7, 2009

(51) Int. Cl. B25J 19/04; B25J 19/02

(52) U.S. Cl. 700/259; 700/258

(57) ABSTRACT

Embodiments of systems and methods for robotic manipulation using electric field pretouch are generally described herein. Other embodiments may be described and claimed.

### TECHNICAL FIELD

The present disclosure relates generally to the field of robotic manipulation and more particularly to methods and related systems for detecting and grasping objects in static and dynamic environments using proximity sensors in a manipulation system.

### BACKGROUND

Robotic systems can be pre-programmed to carry out many complex manipulation tasks in a defined space with known objects in a characterized environment. However, autonomous grasping of a static or moving uncharacterized object in an undefined space presents robotic design challenges. A robotic system exposed to an unknown environment, particularly with humans or other living beings in the environment require that the robotic system be designed to characterize and respond to the environment in real-time. Use of robotic systems in an undetermined and changing environment with the possibility of human interaction necessitates the development of systems and methods to allow the robotic system to recognize and react to a dynamic environment without excessive delay.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is an illustration of an embodiment of a system for robotic manipulation;

FIG. 2 is a block diagram of some embodiments of a robot arm client in communication with a manipulator;

FIG. 3 is an isometric illustration of some embodiments of a base and digit configured with pretouch sensors;

FIG. 4 is a schematic of an embodiment of an electric field sensing mechanism used for detecting an object with variable impedance; and

FIG. 5 is a flowchart that describes some embodiments of a method for detecting, grasping, and repositioning an object.

It will be appreciated that for simplicity and clarity of illustration, elements illustrated in the figures have not necessarily been drawn to scale. For example, the dimensions of some of the elements may be exaggerated relative to other elements for clarity. Further, where considered appropriate, reference numerals have been repeated among the figures to indicate corresponding or analogous elements.

### DETAILED DESCRIPTION

In the following detailed description, numerous specific details of integrated robotic manipulation systems and methods are set forth to provide a thorough understanding of the invention. However, it will be understood by those skilled in the art that the present invention may be practiced without these specific details. In other instances, well-known methods, procedures, components and circuits have not been described in detail so as not to obscure the present invention.

It would be an advance in the art to provide a robotic system capable of performing arm servoing to align a manipulator with a target object, to shape digits in response to a target object shape and orientation, and to grasp the target object either in a static free-standing condition or in a dynamic and unpredictable environment such as when the target object is attached to or held by a person.

One such method for providing robotic manipulation using electric field pretouch is to detect a target object using a long range sensor on a manipulator that further comprises a medium range sensor, a tactile sensor, and a digit. The manipulator is aligned with the target object based at least in part on a long range signal from the long range sensor. The target object is detected using a medium range sensor and the digit is preshaped based at least in part on a medium range signal from the medium range sensor. A baseline signal from the tactile sensor, such as a strain gauge, is determined to indicate a baseline value of the tactile sensor prior to contact of the digit with the target object. The digit is actuated and the tactile sensor is monitored to detect contact with the target object. A baseline encoder value is determined and the digit is actuated to a second encoder value for grasping the target object.

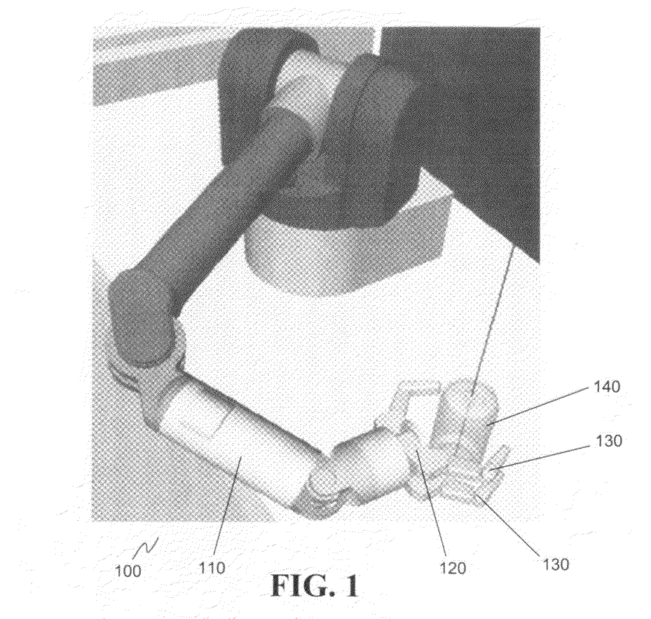

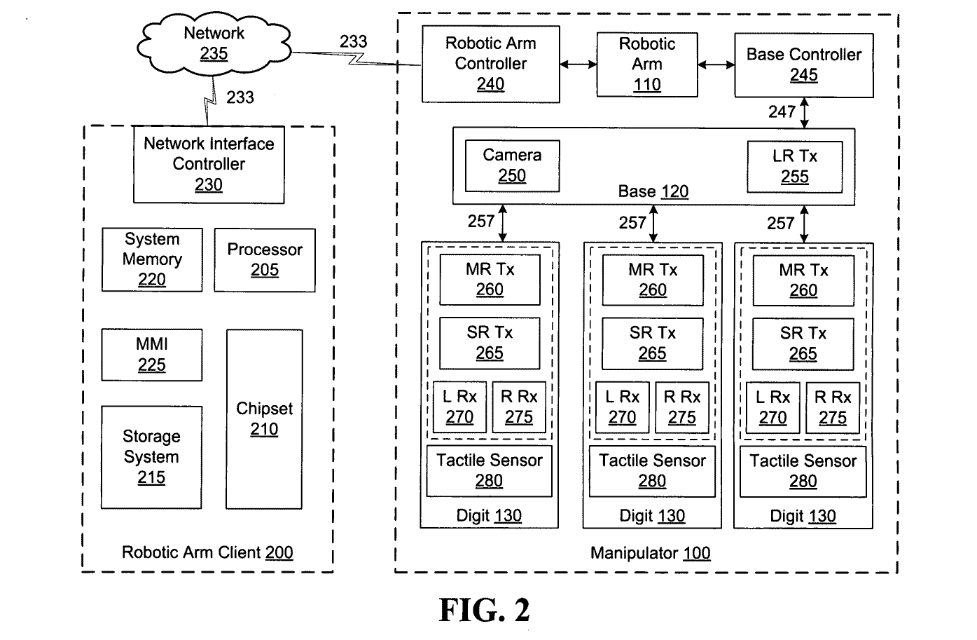

Now turning to the figures, FIG. 1 is an illustration of an embodiment of a robotic system comprising a positioning mechanism and manipulator 100 used to manipulate a target object 140. The robotic system of FIG. 1 comprises a robotic arm 110, a base 120, and a plurality of digits 130 in proximity to the target object 140. The combination of the base 120, and the plurality of digits 130, as further described in FIG. 2 form the manipulator 100. In this embodiment, the positioning mechanism is a robotic arm 110 configured with one or more servoing systems to provide multiple degrees of freedom, for example a four-degree of freedom configuration or a seven-degree of freedom configuration to provide trajectory control in a variety of applications. The base 120 is connected to the robotic arm 110 to position the base 120 and digits 130 proximate to the target object 140.

The embodiment illustrated in FIG. 1 illustrates a base 120 with digits 130 that resembles a palm with fingers, but the embodiment is not so limited. The base 120 and digits 130 may be designed in response to particular requirements to provide a manipulator that is capable of grasping, gripping, and/or orienting of a wide variety of target objects 140. For example, the digits 130 may be driven by independent and dedicated actuators, each actuator configured to move each digit 130 synchronously with one or more other digits 130 to orient each digit 130 over an irregular or oddly shaped target object 140 in a manufacturing, business, or a home environment. The robotic system of FIG. 1 is illustrated with three digits 130, however fewer or additional digits 130 may be provided in response to the application or environment where the robotic system will be used and type(s) and/or shape of the one or more target objects 140.

FIG. 2 is a block diagram of some embodiments of a robotic arm client 200 in communication with the manipulator 100. The robotic arm client 200, such as a personal computer or electronic controller, may be used to perform sensing, inverse kinematics, application logic, and other functions for the robotic arm 110. According to these embodiments, the robotic arm client 200 provides commands to the manipulator 100 at a frequency rate between 1 Hertz (Hz) and 100 Hz or more preferably between 10 Hz and 30 Hz. A higher frequency rate is selectively applied when a higher manipulator speed is desired, subject to constraints such as computer operating speed, communication of computer commands, or other hardware limitations.

Robotic arm client 200 may be a mobile station or a relatively fixed system with various hardware components such as a processor 205, referred to here as a host or central processing unit (CPU), communicatively coupled to various other components via one or more system buses or other communication pathways or mediums. For example, processor 205 may be communicatively coupled to one or more volatile and/or nonvolatile data storage devices e.g., system memory 220 in the form of random access memory (RAM) or read-only memory (ROM) and one or more high capacity storage systems 215. Processor 205 may also be communicatively coupled to one or more network interface controllers (NICs) 230, video controllers, integrated drive electronics (IDE) controllers, small computer system interface (SCSI) controllers, universal serial bus (USB) controllers, input/output (I/O) ports, input devices, and output devices.

In the embodiment illustrated in FIG. 2, processor 205 includes a plurality of processing units. Alternatively, the robotic arm client 200 may include a processor 205 with one processing unit, or multiple processors, each having at least one processing unit. In systems with multiple processing units, those processing units may be implemented as processing cores, as Hyper-Threading (HT) technology, or as any other suitable technology for executing multiple threads simultaneously or substantially simultaneously.

Chipset 210 may include one or more bridges or hubs for communicatively coupling system components, as well as other logic and storage components such as the storage system 215, which may be a hard drive or a solid state disk (SSD).

Some components may be implemented as adapter cards with interfaces (e.g., a PCI connector) for communicating with a bus. In one embodiment, one or more devices may be implemented as embedded controllers, using components such as programmable or non-programmable logic devices or arrays, ASICs, embedded computers, smart cards, and the like. For purposes of this discussion, the term “ROM” may be used in general to refer to nonvolatile memory devices such as erasable programmable ROM (EPROM), electrically erasable programmable ROM (EEPROM), flash ROM, flash memory, etc. Also, the term “bus” refers to shared communication pathways, as well as point-to-point pathways.

Robotic arm client 200 may be controlled, at least in part, by input from a man-machine interface (MMI) 225 including conventional input devices, such as a keyboard, a mouse, etc., and/or by directives received from another machine, biometric feedback, or other input sources or signals. Robotic arm client 200 may utilize one or more connections to one or more remote data platforms through a wired or wireless network 235, such as through network communication links 233 transmitted and received by the NIC 230, a modem, or other communication ports or couplings. Robotic arm client 200 may be interconnected to form a data processing environment through use of the physical and/or logical network, such as a local area network (LAN), a wide area network (WAN), an intranet, the Internet, etc. Communications involving the network 235 may utilize various wired and/or wireless short range or long range carriers and protocols, including radio frequency (RF), satellite, microwave, Institute of Electrical and Electronics Engineers (IEEE) 802.11, 802.16, 802.20, Bluetooth, optical, infrared, cable, laser, etc. Protocols for 802.11 may also be referred to as wireless fidelity (WiFi) protocols. Protocols for 802.16 may also be referred to as worldwide interoperability for microwave access (WiMAX) or wireless metropolitan area network (WirelessMAN) protocols, and information concerning those protocols is currently available at grouper.ieee.org/groups/802/16/index.html.

Embodiments may be described herein with reference to data such as instructions, functions, procedures, data structures, application programs, configuration settings, etc. For purposes of this disclosure, the term “program” covers a broad range of software components and constructs, including applications, drivers, processes, routines, methods, modules, and subprograms. The term “program” can be used to refer to a complete compilation unit (i.e., a set of instructions that can be compiled independently), a collection of compilation units, or a portion of a compilation unit. Thus, the term “program” may be used to refer to any collection of instructions which, when executed by the robotic arm client 200, perform a desired operation or operations. The programs in the robotic arm client 200 may be considered components of a software environment.

The manipulator 100 is comprised of a collection of mechanisms, drive systems, sensors, and controllers and may be coupled to the robotic arm client 200 as illustrated in FIG. 2 or combined with the robotic arm client 200 (not shown) as a single unit. A robotic arm controller 240, which may be similar in configuration and in communication with the robotic arm client 200 through the network 235, is used for real-time control of the robotic arm 110 that is part of the manipulator 100 in this embodiment, but may be separate from the manipulator 100. In one embodiment, the robotic arm controller 240 provides real-time commands to the robotic arm 110 at a frequency rate between 100 Hz and 1000 Hz or more preferably between 250 Hz and 750 Hz.

For example, the robotic arm controller 240 provides arm movement commands at a rate of approximately 500 Hz for movements along pre-planned trajectories. In another example, sensing and control functions are integrated thereby allowing the manipulator 100 to travel according to dynamically generated trajectories in response to some combination of visual sensor data, pretouch sensor data, or commands from a program. Movement in response to sensor data differs from a pre-planned trajectory as the next known location or position for the arm is not knowable until a subsequent sensor value is collected. Pre-planned trajectories may provide for smooth arm movement since only interpolation of data is normally required. Dynamically generated trajectories, such as those trajectories generated from sensor data can require extrapolation of data for the movement of the manipulator 100. However, extrapolation of data may introduce tremulous manipulator 100 behavior since an extrapolated travel path is based only on previously known data.

To overcome the issue of an extrapolated travel path, a small amount of lag-time may be introduced between commands issued by the robotic arm client 200 and those sent by the robotic arm controller 240. Movement calculations that would otherwise require extrapolation is reduced to interpolation between previously executed commands and a future command that can be known as a result of the lag-time introduced. Robotic arm 110 movements become more stable as more lag-time is allowed. However, increases in lag-time also contribute to additional and undesirable latency. A lag-time ranging between 40-60 ms may be used to provide smooth operation of the robotic arm 100 without introducing excessive latency.

A base controller 245 is provided in this embodiment to communicate with the base 120 through a connection such as a universal serial bus connection 247. The base 120 may communicate with each digit 130 through a communication path such as an inter-integrated circuit (I2C) connection 257. When a measurement or a sensor reading is requested, the base 120 queries each of the digits 130 over the I2C and then transmits back measurements to the base controller 245. The base 120 is configured with a long range transmitter 255 to sense or pretouch objects further away from the base 120. In this embodiment, the base 120 also comprises a camera 250 to provide visual sensory information to the base controller 245.

Pretouch is a sensor response that provides longer range sensing than that provided by a tactile sensor but shorter range than what might be provided using a vision sensor such as the camera 250. The digits 130 comprise a plurality of sensors to allow the manipulator 100 to pretouch a target object 140. A medium range transmitter 260 is located along a portion of the digit 130 and is nearly adjacent to a short range transmitter 265 that is also located along a portion of the digit 130. The medium range transmitter 260, the short range transmitter 265, and the long range transmitter 255 of the base 120 are configured to communicate as fingerling electrodes with a left receiver 270 and/or a right receiver 275 located in the tip of the digit 130 to sense an electric field between the receiver and at least one of the transmitters. Fewer or additional transmit and receiver electrodes may be provided in the digit 130, depending on the application in alternate embodiments.

Placement of the transmit electrodes; short range transmitter 265, medium range transmitter 260, and long range transmitter 255 contributes in-part to a measurement range. Other parameters that may influence the measurement range are spacing between transmit (e.g. MR Tx 260 and LR Tx 255) and receive electrodes (e.g. L Rx 270 and R Rx 275), size and shape of the electrodes, and the surface area of the electrodes. In one embodiment, a short range measurement provided by the short range transmitter 265 and left receiver 270 or right receiver 275 transmit/receive pair is a high resolution measurement with a range of approximately between 1 millimeter (mm) and 2 centimeters (cm) or more preferably between 0.5 cm to 1.5 cm. A medium range measurement provided by the medium range transmitter 260 and left receiver 270 or right receiver 275 transmit/receive pair is a measurement with a range of approximately between 1 cm and 6 cm or more preferably between 3 cm and 5 cm. Further, a long range measurement provided by the long range transmitter 255 and left receiver 270 or right receiver 275 transmit/receive pair is a measurement with a range of approximately 10 to 15 cm. A configuration as illustrated in FIG. 2 employing a plurality of receivers including the left receiver 270 and the right receiver 275 allows each digit 130 to sense directional information in regards to location of the target object 140 of FIG. 1.

In addition, a tactile sensor 280 is provided to allow the manipulator 100 to sense an amount of stress exerted on the digit 130 or a portion of the digit 130 or an amount of strain sensed by the tactile sensor 280. The tactile sensor 280 may sense strain of the digit 130, for example when the manipulator 100 actuates one or more digits 130 to contact and/or grasp a target object 140.

The variety of electric field pretouch sensors, including the short range transmitter 265, medium range transmitter 260, and long range transmitter 255 combined with the left receiver 270 and/or the right receiver 275, tactile sensors and related circuitry (not shown) comprises an integrated manipulator 100. The manipulator 100 is guided using electric field pretouch that when combined with a servoing system allows the manipulator 100 to align with a target object 140, to pre-shape digits 130 and to grasp the target object 140 that may be free standing, moving, or held.

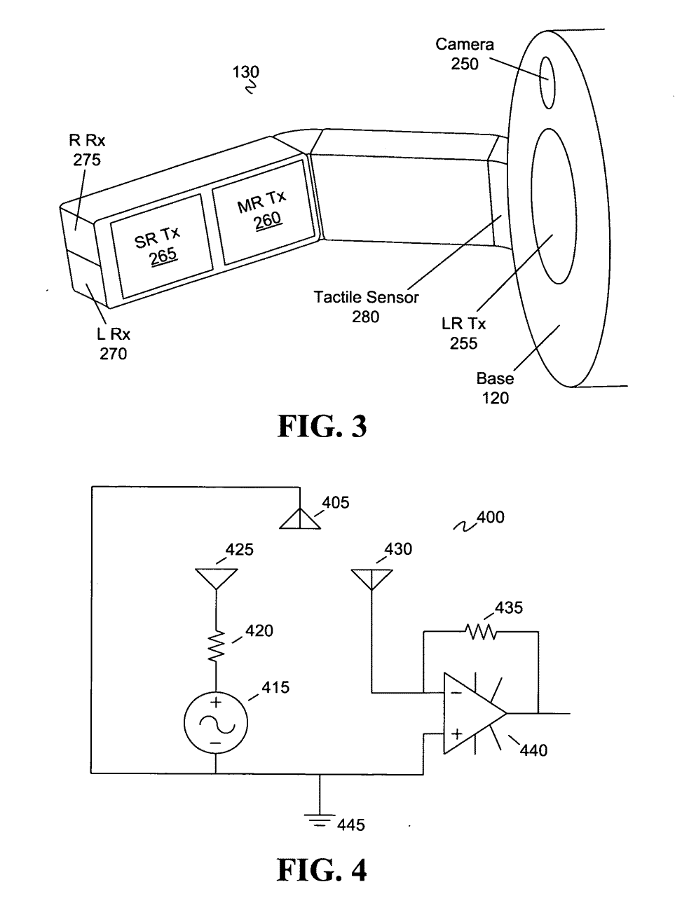

FIG. 3 is an isometric illustration of the base 120 and the digit 130 of FIG. 2 configured with sensors according to some embodiments of the invention. The camera 250 illustrated in this embodiment provides an ability for the manipulator 100 to detect a target object 140 that is outside a range of detection provided by the electric field pretouch sensors (e.g. LR Tx 255, MR Tx 260, R Rx 275, etc.). For example, the camera 250 may detect a presence of the target object 140 prior to detection by the electric field pretouch sensors, thereby allowing the manipulator 100 to position proximate to the target object 140, or close enough to allow the electric field pretouch sensors to detect the target object 140. However, application of a visual sensor such as the camera 250 is optional.

The long-range transmitter 255 is illustrated as a single transmitter, however, additional long-range transmitters may be configured on various portions of the base to provide a plurality of long-range transmit/receive pairs. Further, one or more medium range transmitters 260 may be placed on the digit 130 proximate to the tactile sensor (280) to provide a desired sensor range of measurements. One digit 130 is illustrated in FIG. 3 for simplicity, but additional digits 130 may be provided depending on the desired application. Further, the digit 130 may be designed with fewer or additional joints to provide desired grasping capabilities. One or more encoders (not shown) provide positional information of the one or more digits 130 in relation to the base 120.

FIG. 4 is a schematic of an electric field sensing mechanism 400 used for detecting the target object 140. The electric field sensing mechanism 400 of FIG. 4 may be used in some embodiments of the invention to detect the presence of the target object 140. As an example, an alternating current (AC) signal is applied from a voltage source 415 and source resistor 420 to one or more transmit electrodes 425, such as the long range transmitter 255 of FIG. 3. In turn, the AC signal from the transmit electrode 425 induces an AC signal in one or more receive electrodes 430, such as the left receiver 270 of FIG. 3. The AC signal received by the receive electrode 430 is amplified and processed by an analog front end 440 such as a current amplifier with feedback resistor 435 to measure current induced at the receive electrode 430. Output from the analog front end 440 may be further processed by an analog to digital controller (ADC) and subsequently processed by software or a program in a microcontroller or other processor (not shown). The target object 140 of FIG. 1, illustrated in FIG. 4 as sensed object 405, modifies the current induced in the analog front end 440 by interacting with the transmit electrode 425 and the receive electrode 430. The sensed object 405 may be electrically grounded to some extent or electrically floating.

In an embodiment where the sensed object 405 is electrically grounded, bringing the sensed object 405 closer to the transmit electrode 425 and receive electrode 430 transmit/receive pair absorbs or diminishes displacement current that would have otherwise reached the receive electrode 430, decreasing a measured sensor value. In another embodiment, bringing an electrically floating sensed object 405 near the transmit electrode 425 and receive electrode 430 transmit/receive pair induces or causes additional displacement current to reach the receive electrode 430, increasing the measured sensor value. The electrically floating sensed object 405 effectively shortens a distance through which an electric field has to otherwise propagate through the air.

As a result, when the sensed object 405 is brought in the proximity of a transmit/receive pair of electrodes such as the long range transmitter 255 and the left receiver 270 of FIG. 2, the sensor values may be increased or decreased depending on the coupling of the sensed object 405 to electrical ground. For example, humans as well as a target object 140 held by a human are normally well-coupled to electrical ground. If the sensed object 405 is a human, current that would have otherwise reached the receive electrode 430 is absorbed or otherwise diminished, decreasing a measured sensor value.

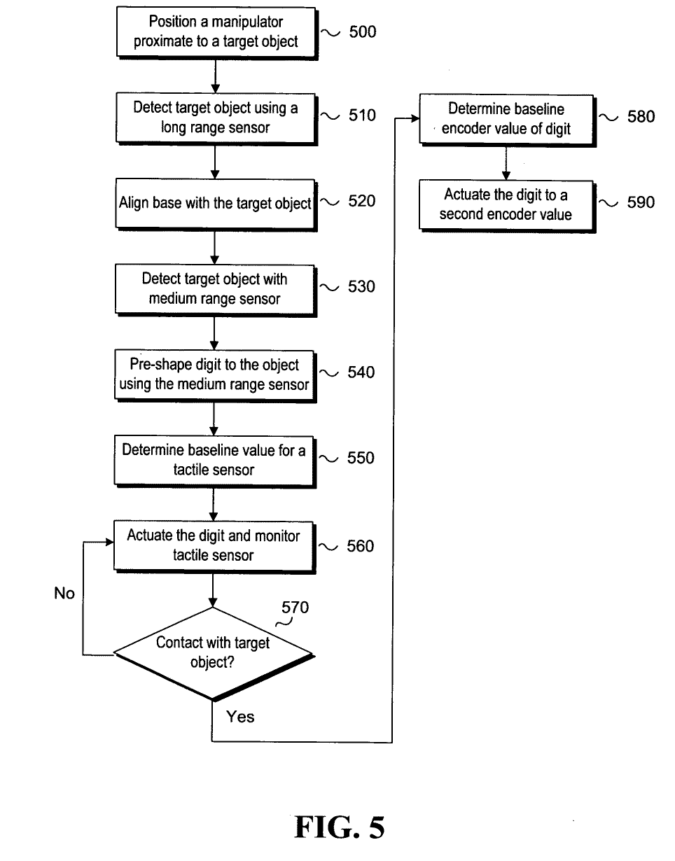

FIG. 5 is a flowchart that describes a method for manipulating a target object with a manipulator 100 using electric field pretouch in which an embodiment of the invention may be implemented. In element 500, the target object 140 is positioned proximate to the manipulator 100. The target object 140 may be placed proximate to the base 120 or the base 120 may be placed proximate to the target object 140, such as by visually sensing the target object 140 using the camera 250 and moving the base 120 to the target object 140. The target object 140 may be static or moving in reference to the base 120.

The target object 140 is detected with a long range sensor comprising a long range transmitter 255 and either the left receiver 270 and/or the right receiver 275 transmit/receive pair in element 510. The base 120 of the manipulator 100 is aligned with the target object 140 in element 520 based at least in part using a long range sensor measurement value. The target object 140 is detected in element 530 based at least in part using a medium range sensor measurement value provided by the medium range transmitter 260 and either the left receiver 270 and/or the right receiver 275 transmit/receive pair. However, one or more other transmit/receive pairs may be used in conjunction with the medium range transmitter 260 and either the left receiver 270 and/or the right receiver 275 transmit/receive pair to detect the target object 140.

In element 540, the digit 130 is pre-shaped to the target object 140 based at least in part on the medium range transmit/receive pair. In another embodiment, the digit 130 may be further aligned with the target object 140 using the short range transmitter 265 and either the left receiver 270 and/or the right receiver 275 transmit/receive pair. For example, a short range sensor comprising the short range transmitter 265 and either the left receiver 270 and/or the right receiver 275 transmit/receive pair is used to modify a preshape position in response to a short range sensor measurement value. A baseline value for the tactile sensor 280, which may be a form of a stress gauge or a strain gauge, is determined in element 550 to indicate a measurement value for the tactile sensor 280 prior to contact with the target object 140.

The digit 130 is actuated in element 560 and the tactile sensor 280 is monitored to determine whether the digit 130 has contacted the target object 140. When the tactile sensor 280 has contacted the target object 140, a baseline encoder value for the digit 130 is determined in element 580 to provide the manipulator with a reference value for initial contact with the target object 140. The digit 130 is actuated to a second encoder value in element 590 to allow the digit to grasp or secure the target object 140. The target object 140 is grasped using digits 130 and the base 120 in element 540 and may be held in place or moved according to instructions provided to the manipulator 100, such as by the robotic arm client 200 of FIG. 2 through network 235. Tactile sensors 280 may further be used to determine if the target object 140 is held steady in reference to the base 120 in element 550. If the target object 140 is slipping, the tactile sensors 280 may detect movement and re-grasp the target object 140 using the digits 130. Further, the manipulator 100 may reposition the target object 140 while monitoring for slip.

The operation discussed herein may be generally facilitated via execution of appropriate firmware or software embodied as code instructions on the host processor and microcontroller, as applicable. Thus, embodiments of the invention may include sets of instructions executed on some form of processing core or otherwise implemented or realized upon or within a machine-readable medium. A machine-readable medium includes any mechanism for storing or transmitting information in a form readable by a machine (e.g., a computer). For example, a machine-readable medium can include an article of manufacture such as a read only memory (ROM); a random access memory (RAM); a magnetic disk storage media; an optical storage media; and a flash memory device, etc. In addition, a machine-readable medium may include propagated signals such as electrical, optical, acoustical or other form of propagated signals (e.g., carrier waves, infrared signals, digital signals, etc.).

In the following description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other while “coupled” may further mean that two or more elements are not in direct contact with each other, but yet still co-operate or interact with each other.

While certain features of the invention have been illustrated and described herein, many modifications, substitutions, changes, and equivalents will now occur to those skilled in the art. It is, therefore, to be understood that the appended claims are intended to cover all such modifications and changes as fall within the true spirit of the invention.

What is claimed is:

1. A robotic system with electric field pretouch, comprising:
a robotic arm client, and;
a manipulator coupled to the robotic arm client, the manipulator comprising;
a base with a long range transmitter;
a digit connected to the base, the digit comprising a medium range transmitter and a receiver to sense an electric field between the receiver and at least one of the transmitters;
a tactile sensor connected to the base and the digit, wherein the tactile sensor is configured to measure a strain of the digit; and
an encoder, wherein the encoder is configured to monitor a position of the digit.

2. The robotic system of claim 1, further comprising a short range transmitter.

3. The robotic system of claim 2, further comprising a vision sensor connected to the base.

4. The robotic system of claim 1, wherein the robotic arm client communications with the manipulator through a network.

5. The robotic system of claim 1, wherein the robotic arm client provides commands to the manipulator at a frequency rate between 10 and 30 Hertz.

6. The robotic system of claim 1, wherein the manipulator further comprises a robotic arm controller and a robotic arm.

7. The robotic system of claim 6, wherein the robotic arm controller provides commands to the robotic arm at a frequency rate between 250 and 750 Hertz.

8. A method for robotic manipulation using electric field pretouch, comprising:
detecting a target object using a long range sensor on a manipulator, the manipulator further comprising a medium range sensor, a tactile sensor, and a digit;
aligning the manipulator with the target object;
detecting the target object using a medium range sensor and preshaping the digit to the target object;
determining a baseline value of the tactile sensor;
grasping the target object with the digit and monitoring a tactile sensor to detect contact with the target object;
determining a baseline encoder value of the digit; and
actuating the digit to a second encoder value.

9. The method of manipulation of claim 8, further comprising detecting the target object with a short range sensor and modifying a preshape position in response to a short range sensor measurement value.

10. The method of claim 8, further comprising repositioning the target object and monitoring slip of the target object.

11. The method of claim 8, further comprising using a camera for vision sensing of the target object.

12. The method of claim 8, wherein the target object is detected in a range between 10 and 15 centimeters (cm) using the long range sensor.

13. The method of claim 12, wherein the target object is detected in a range between 3 and 5 centimeters (cm) using the medium range sensor.

14. The method of claim 9, wherein the target object is detected in a range between 0.5 to 1.5 centimeters (cm) using the short range sensor.

15. A machine-accessible medium that provides instructions, which when accessed, cause a machine to perform operations comprising:
detecting a target object using a long range sensor on a manipulator, the manipulator further comprising a medium range sensor, a tactile sensor, and a digit;
aligning the manipulator with the target object;
detecting the target object using a medium range sensor and preshaping the digit to the target object;
determining a baseline value of the tactile sensor;
grasping the target object with the digit and monitoring a tactile sensor to detect contact with the target object;
determining a baseline encoder value of the digit; and
actuating the digit to a second encoder value.

16. The machine-accessible medium of claim 15, further comprising detecting the target object with a short range sensor and modifying a preshape position in response to a short range sensor measurement value.

17. The machine-accessible medium of claim 15, further comprising repositioning the target object and monitoring slip of the target object.

18. The machine-accessible medium of claim 15, further comprising using a camera for vision sensing of the target object.

19. The machine-accessible medium of claim 15, wherein the target object is detected in a range between 10 and 15 centimeters (cm) using the long range sensor.

20. The machine-accessible medium of claim 19, wherein the target object is detected in a range between 3 and 5 centimeters (cm) using the medium range sensor.
